(19) United States
(12) Patent Application Publication
(10) Pub. No.: US 2016/0138515 A1
(43) Pub. Date: May 19, 2016

(54) CYLINDER HEAD FOR ENGINE

(71) Applicant: Hyundai Motor Company, Seoul (KR)

(72) Inventors: Hong Kil Baek, Seoul (KR); In Woong Lyo, Suwon (KR); Jiyoun Seo, Suwon (KR); Bokyung Kim, Yongin (KR); Seung Woo Lee, Seoul (KR); Tae Won Lee, Incheon (KR)

(73) Assignee: HYUNDAI MOTOR COMPANY, Seoul (KR)

(21) Appl. No.: 14/722,346

(22) Filed: May 27, 2015

(30) Foreign Application Priority Data
Nov. 14, 2014 (KR) 10-2014-0158785

(51) Int. Cl. F02F 1/42; B05D 7/00

(52) U.S. Cl. CPC F02F 1/4235; B05D 7/584

(57) ABSTRACT

Disclosed is a cylinder head for an engine. The cylinder head for an engine includes an insulation coating layer formed on a surface of an intake port surface. The insulation coating layer comprises a polyamideimide resin and an aerogel in the polyamideimide resin, for example, as being dispersed, and the insulation coating layer has a thermal conductivity of 0.60 W/m or less.

### CROSS-REFERENCE TO RELATED APPLICATION

The present application claims priority of Korean Patent Application Number 10-2014-0158785 filed on Nov. 14, 2014, the entire contents of which application are incorporated herein for all purposes by this reference.

### TECHNICAL FIELD

The present invention relates to an engine for a vehicle. More particularly, the present invention relates to a cylinder header for an engine where an insulation coating layer is formed on a surface of an intake port.

### BACKGROUND

In general, an internal combustion engine converts heat energy by applying combustion gas generated by combusting a fuel to a piston or a turbine blade. The internal combustion engine generally refers to an engine having reciprocal motion to move a piston by igniting a mixed gas of a fuel and air inside a cylinder, and a gas turbine jet rocket is one of the internal combustion engines. The internal combustion engine may be classified into a gas engine, a gasoline engine, and a petroleum engine according to a fuel used. A petroleum gas gasoline engine is ignited by an electric spark of a spark plug, and a diesel engine is naturally ignited by injecting a fuel in high temperature and high pressure air. A stroke type of the piston includes a 4 stroke cycle type and a 2 stroke cycle type.

In general, it is known that the internal combustion engine of a vehicle has heat efficiency in the range of about 15% to 35%. However, about 60% or greater of the total heat energy may be consumed due to heat energy and exhaust gas released to the outside through a wall of the internal combustion engine even in maximum efficiency of the internal combustion engine. Since the efficiency of the internal combustion engine may be increased when an amount of heat energy to be released to the outside through a wall of the internal combustion engine is reduced, a method in which an insulation material is installed outside of the internal combustion engine, a part of a material or a structure of the internal combustion engine is changed, or a cooling system of the internal combustion engine is changed has been developed.

Particularly, the efficiency of the internal combustion engine and fuel consumption of a vehicle may be improved by minimizing release of heat generated in the internal combustion engine to the outside along a wall of the internal combustion engine. However, researches into an insulation material or an insulation structure capable of being maintained for extended time inside the internal combustion engine to which repeated high temperature and high pressure conditions are applied have not been sufficiently conducted.

The above information disclosed in this section is only for enhancement of understanding of the background of the invention and therefore it may contain information that does not form the prior art that is already known in this country to a person of ordinary skill in the art.

### SUMMARY

In preferred aspects, the present invention provides a cylinder head of an engine that may have advantages of reducing knocking of an engine by suppressing a temperature increase of intake air by applying an insulation coating layer. In particular, the insulation coating layer applied on the cylinder head may have a high mechanical material property and heat resistant property while having low thermal conductivity and low volume heat capacity.

In one aspect, provided is a cylinder head for an engine that may include: an insulation coating layer formed on a surface of an intake port surface. In particular, the insulation coating layer may include a polyamideimide resin and an aerogel. For example, the aerogel may be suitably dispersed in the polyamideimide resin. The insulation coating layer may have a thermal conductivity of about 0.60 W/m or less.

In the cylinder head for an engine according to an exemplary embodiment of the present invention, the insulation coating layer may have heat capacity of about 1250 KJ/m³ K or less. In the cylinder head for an engine according to an exemplary embodiment of the present invention, an amount of about 2 wt % of less may be included in or penetrate the aerogel. In the cylinder head for an engine according to an exemplary embodiment of the present invention, the polyamideimide resin may not be included at a depth of about 5% or greater of a longest diameter from a surface of the aerogel.

Further, in the cylinder head for an engine according to an exemplary embodiment of the present invention, the aerogel may have a pore rate in a range of about 92% to 99% while being dispersed in the polyamideimide resin. The insulation coating layer may have a thickness in a range of about 50 μm to 500 μm and the insulation coating layer may include the aerogel in an amount of about 5 to 50 parts by weight based on the polyamideimide resin at 100 parts by weight.

Further provided are vehicles that may comprise the cylinder heads as described herein.

In another aspect, the present invention provides a method for preparing an insulation coating layer of a cylinder head for an engine. The method may include: preparing an insulation coating composition; applying the insulation coating composition on a surface of a subject; and drying the insulation coating composition. In particular, the insulation coating layer may include a polyamideimide resin and an aerogel in the polyamideimide resin, for example, as being dispersed, and thus, the insulation coating layer having thermal conductivity of about 0.60 W/m or less may be formed.

The insulation coating composition may include the polyamideimide resin dispersed in a first solvent and the aerogel dispersed in a second solvent. The first solvent has a boiling point of about 110° C. or greater and the second solvent has a boiling point of about 110° C. or less. For example, the first solvent may be selected from the group consisting of water, methanol, ethanol, ethyl acetate, and a mixture of at least two thereof and the second solvent may be selected from the group consisting of alcohol, ethyl alcohol, propyl alcohol, n-butyl alcohol, iso-butyl alcohol, tert-butyl alcohol, acetone, methylenechloride, ethylene acetate, isopropyl alcohol, and a mixture of at least two thereof.

In the insulation coating composition or insulation coating layer, the polyamideimide resin may have a weight average molecular weight of about 3000 to 300,000 and the aerogel may be made of at least one compound selected from the group consisting of a silicon oxide, carbon, a polyimide, and a metal carbide.

In the insulation coating composition, a solid content of the polyamideimide resin may be in a range of about 5 wt % to 75 wt % based on the total weight of the first solvent and a solid content of the aerogel may be in a range of about 5 wt % to 75 wt % based on the total weight of the second solvent.

Further, the insulation coating layer may include the aerogel in an amount of about 5 to 50 parts by weight based on the polyamideimide resin at 100 parts by weight.

When drying the insulation coating composition, the method may include: semi-drying the insulation coating composition at a temperature of about 50° C. to 200° C. at least once, and drying the semi-dried insulation coating composition completely dried at a temperature of about 200° C. or greater.

Exemplary subject in the cylinder head for an engine where the insulation coating composition is applied may be an intake port.

Other aspects of the invention are disclosed infra.

### BRIEF DESCRIPTION OF THE DRAWINGS

In the following detailed description, only certain exemplary embodiments of the present invention have been shown and described, simply by way of illustration.

FIG. 1 is a schematic view illustrating an exemplary cylinder head for an exemplary engine according to an exemplary embodiment of the present invention.

FIG. 2 is a photographic view showing a surface of an exemplary insulation coating layer obtained by an exemplary embodiment of the present invention.

FIG. 3 is a photographic view showing a surface of an exemplary coating layer obtained from a comparative example as compared with an exemplary embodiment of the present invention.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, the present invention will be described more fully with reference to the accompanying drawings, in which exemplary embodiments of the invention are shown. As those skilled in the art would realize, the described embodiments may be modified in various different ways, all without departing from the spirit or scope of the present invention. For the purpose of clear description of an exemplary embodiment of the present invention, parts which are not related to the description are omitted. The same reference numbers are used throughout the specification to refer to the same or like parts.

Further, the size and thickness of each configuration shown in the drawings are optionally illustrated for better understanding and ease of description, the present invention is not limited to shown drawings, and the thicknesses are exaggerated for clarity of a plurality of parts and regions. The terms “first” and “second” can be used to refer to various components, but the components may not be limited to the above terms. The present invention is not limited to the order. Throughout this specification, in addition, unless explicitly described to the contrary, the word “comprise” and variations such as “comprises” or “comprising” will be understood to imply the inclusion of stated elements but not the exclusion of any other elements. Further, the terms “ . . . unit”, “ . . . means”, “ . . . part”, and “ . . . member” described in the specification refer to a unit of a general configuration processing at least one function or operations.

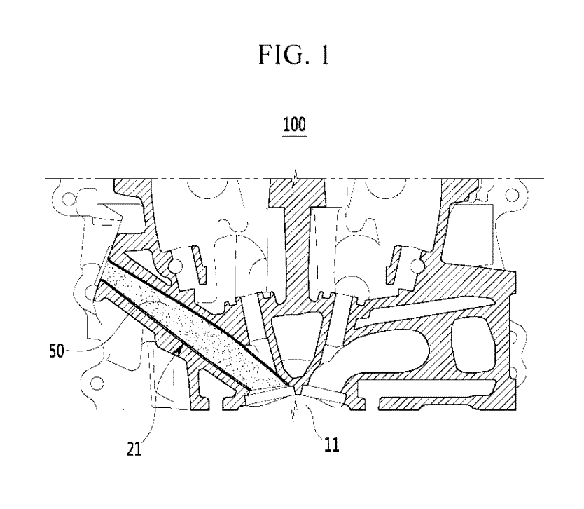

FIG. 1 is a schematic view illustrating an exemplary cylinder head for an engine according to an exemplary embodiment of the present invention. As shown in FIG. 1, the cylinder head 100 for an engine according to an exemplary embodiment of the present invention is formed therein with a combustion chamber 11 for combusting a fuel and air, and is formed therein with an intake port 21 for supplying intake air into the combustion chamber 11.

Hereinafter, although the cylinder head 100 according to an exemplary embodiment of the present invention is applied to the engine of a vehicle by way of example, it should be understood that the scope of the present invention is not limited thereto. A structure of cylinder combustion chamber is applicable to a technical idea of the present invention if the structure is applied to various types and purposes of internal combustion engines such as a gas turbine, a jet engine, and a rocket.

A temperature in the cylinder head 100 of an aluminum material may be increased to a maximum of about 250° C. due to heat released from the combustion chamber 11. When intake air introduced into the combustion chamber 11 from the outside passes through the intake port 21 and is introduced into the combustion chamber 11 as a temperature is increased while absorbing heat, knocking of the engine may occur and heat efficiency of the engine may be deteriorated.

The cylinder head 100 for an engine according to the an exemplary embodiment of the present invention may have a structure capable of reducing knocking of an engine by suppressing an increase in a temperature of the intake air introduced upon an intake stroke according to a low volume heat capacity characteristic. In particular, an insulation coating layer 50 having high mechanical material property and heat resistant property while having low thermal conductivity and low volume heat capacity may be applied on a surface of the intake port 21.

Further, an exemplary embodiment of the present invention may provide: the cylinder head 100 for an engine capable of improving fuel consumption by ignition timing advance due to knocking reduction by suppressing an increase in a temperature of intake air and improving engine output due to an increase of intake charging efficiency. Hereinafter, the insulation coating layer 50 may be applied to a surface of the intake port 21 of the cylinder head 100 for the engine and an insulation coating composition thereof will be described in detail.

The present invention may provide an insulation coating composition that may include: a polyamideimide resin dispersed in a first solvent and an aerogel dispersed in a second organic solvent. The first solvent may be a solvent having high boiling point organic or an aqueous solvent, and the second solvent may have a low boiling point. Moreover, the insulation coating layer may include a polyamideimide resin and an aerogel dispersed in the polyamideimide resin, and thus, the insulation layer may have a thermal conductivity of about 0.60 W/m or less. As used herein, the “high boiling point” means a boiling temperature of a solvent of about 110° C. or greater, and the “low boiling point” means a boiling temperature of a solvent of about 110° C. or less. Further, the “aqueous solvent” refers to a solvent or a solvent system that may include at least a portion of water, or further, that may be water-soluble or be mixed with water without separation. For example, according to exemplary embodiments of the present invention, water, methanol, ethanol, ethyl acetate, other polar solvent that may be water soluble, and mixtures thereof may be used as an aqueous solvent.

According to an exemplary embodiment of the present invention, an insulation coating composition may include: a polyamideimide resin dispersed in a high boiling point organic solvent or an aqueous solvent; and an aerogel dispersed in a low boiling point organic solvent. Inventors of the present invention have confirmed through the experiments to obtain the invention that when a coating composition obtained by dispersing the polyamideimide resin and the aerogel in each predetermined solvent, i.e. the first solvent and the second solvent, respectively, and by mixing the polyamideimide resin and the aerogel with predetermined solvents is used, and a coating layer obtained therefrom may have improved mechanical material property and heat resistant property. Meanwhile, thermal conductivity and density of the coating layer may be reduced. Accordingly, the coating composition may be applied to the internal combustion engine such that heat energy released to the outside may be reduced to improve the efficiency of the internal combustion engine and fuel consumption of the vehicle.

In recent years, methods of using aerogel or air-gel in fields such as for a heat insulating material, an impact buffer material, or a sound proofing material have been proposed. The aerogel has a structure where fine fibers having a thickness of about 1/10,000 of a hair are entangled and the aerogel may form a pore rate of about 90% or greater. The pore rate of a coating is defined as a ratio of volume of void of the coating per total volume of the coating. Exemplary material of the aerogel may include silicon oxide, carbon, or an organic polymer. Particularly, the aerogel may have a substantially low density and high transparent and very low thermal conductivity because of the above structural characteristic.

However, even though the aerogel has an excellent insulation characteristics, since the aerogel may be easily broken from a small impact due to high brittleness, and has a difficulty in being processed into various thicknesses and forms, there may be a limitation in using it as a heat insulating material. Further, when the aerogel is mixed with other reaction materials, a solvent or solute may penetrate into the aerogel so that viscosity of a resulting aerosol material may be increased and mixing may not be sufficiently performed. Accordingly, the aerogel has not been used as being integrated with other materials or as being mixed with other materials that do not have the porosity as the aerogel.

In contrast, in an example of the insulation coating composition, the polyamideimide resin may be dispersed in a first solvent, such as the high boiling point organic solvent or the aqueous solvent, and the aerogel may be dispersed in a second solvent that may be the low boiling point organic solvent. Accordingly, a dispersion phase of the polyamideimide resin in the first solvent may not be combined with a dispersion phase of the aerogel in the second solvent to be uniformly mixed with each other, and the insulation coating composition may also have a uniform composition.

Further, since the first solvent such as high boiling point organic solvent or the aqueous solvent and the second solvent such as low boiling point organic solvent may not be easily dissolved or mixed with each other, the first solvent and the second solvent may be mixed with each other when the polyamideimide resin is dispersed in the first solvent and the aerogel is dispersed in the second solvent. Accordingly, before the example of the insulation coating composition is coated and dried, direct contact between the polyamideimide resin and the aerogel may be minimized, and the polyamideimide resin may be prevented from penetrating or impregnating into pores of the aerogel.

Moreover, since the second solvent such as low boiling point organic solvent has a predetermined affinity with the first solvent such as high boiling point organic solvent or the aqueous solvent, the second solvent may allow the aerogel dispersed therein to be physically mixed with the first solvent to be uniformed distributed, and allow the polyamideimide resin to be uniformly distributed in the first solvent. Accordingly, an insulation coating layer obtained from the example of the insulation coating composition may ensure an equivalent physical material of the aerogel, and the aerogel may be uniformly dispersed in the polyamideimide resin thereby improving mechanical properties, heat resistant property, and insulation characteristics.

That is, as described above, the insulation coating layer obtained from the example of the insulation coating composition may maintain the equivalent level of the material property and structure of the aerogel, high mechanical properties, and heat resistant property may be ensured while representing low thermal conductivity and a low density, and thus, the insulating coating layer may be applied to an internal combustion engine such that externally released heat energy may be reduced to improve efficiency of the internal combustion engine and fuel consumption of the vehicle.

For example, as shown in FIG. 1, the insulation coating layer 50 may be applicable to a surface of an intake port 21 of the cylinder head 100. As described above, the insulation coating composition may be formed by mixing the polyamideimide resin dispersed in the high boiling point organic solvent or the aqueous solvent with the aerogel dispersed in the low boiling point organic solvent. The mixing method may not be particularly limited, but may be a generally known physical mixing method in the related arts. For example, when the two types of solvent dispersion phases may be mixed with each other, zirconia beads may be added to the mixture, and ball milling may be performed at a room temperature under normal pressure condition at speed of about 100 to 500 rpm to manufacture a coating composition (coating solution). However, the method of mixing the solvent of the polyamideimide resin with the solvent of the aerogel may not be limited to the above example.

The example of the insulation coating composition may provide an insulation material or an insulation structure which may be maintained for a long time inside the internal combustion engine to which high temperature and high pressure condition are repeatedly applied. In detail, the example of the insulation coating composition may be used to as a coating material of an internal surface of the internal combustion engine or a component of the internal combustion engine. In particular, as described above, the example of the insulation coating composition may be used to coat a surface of the intake port of the cylinder head.

An example of the polyamideimide resin included in the insulation coating composition may not be limited, but the polyamideimide resin may have a weight average molecular weight of about 3000 to 300,000, or particularly of about 4000 to 100,000. When the weight average molecular weight of the polyamideimide resin is less than the predetermined value, for example, less than about 3000, it may be difficult to obtain sufficient mechanical properties or heat resistant property and insulation property of the coating layer or a coating film obtained from the insulation coating composition, and a polymer resin may easily penetrate into the aerogel.

Further, when the weight average molecular weight of the polyamideimide resin is greater than the predetermined value, for example, greater than about 300,000, uniformity of the coating layer or a coating film obtained from the insulation coating composition may be deteriorated, dispersion of the aerogel in the insulation coating composition may be deteriorated, or blockage of a nozzle and the like of a coating device upon coating the insulation coating composition may occur. In addition, it may take extended time to perform heat treatment of the insulation coating composition and the heat treatment temperature may be increased.

A generally known aerogel may be used as the aerogel. In detail, an aerogel of a component including a silicon oxide, carbon, a polyimide, a metal carbide, or a mixture of at least two thereof may be used as the aerogel. The aerogel may have a specific surface area of about 100 cm³/g to 1000 cm³/g, or particularly, of about 300 cm³/g to 900 cm³/g. The insulation coating composition may include the aerogel in an amount of about 5 to 50 parts by weight, or particularly in an amount of about 10 to 45 parts by weight, based on 100 parts by weight of the polyamideimide resin. A weight ratio of the polyamideimide resin to the aerogel may be a weight ratio of a solid content excluding the dispersion solvent.

When the content of the aerogel based on the polyamideimide resin is less than the predetermined amount, for example, less than about 5 parts by weight, it may be difficult to reduce thermal conductivity and a density of the coating layer or a coating film obtained from the insulation coating composition, and a heat resistant property of an insulation layer manufactured from the insulation coating composition may be reduced. When the content of the aerogel based on the polyamideimide resin is greater than the predetermined amount, for example, greater than about 50 parts by weight, it may be difficult to sufficiently obtain mechanical properties of the coating layer or a coating film obtained from the insulation coating composition, and cracks may occur in an insulation layer manufactured from the insulation coating composition or it may be difficult to firmly maintain a coating form of the insulation layer.

Although the solid content of the polyamideimide resin in the first solvent such as the high boiling point organic solvent or the aqueous solvent may not be limited, the solid component of polyamideimide may be in the range of about 5 wt % to 75 wt % based on the total weight of the first solvent in consideration of the uniformity or a material property of the insulation coating composition. Although the solid content of the aerogel in the second solvent such as the low boiling point organic solvent may not be limited, the solid component may be in the range of about 5 wt % to 75 wt % based on the total weight of the second solvent in consideration of the uniformity or the material property of the insulation coating composition.

As described above, since the first solvent and the second solvent are not easily dissolved or mixed with each other, before the insulation coating composition is coated and dried, direct contact between the polyamideimide resin and the aerogel may be minimized, and the polyamideimide resin may be prevented from penetrating or impregnating into the inside of pores of the aerogel.

In particular, the difference in boiling temperature between the first solvent and the second solvent may be about 10° C. or higher, or about 20° C. or greater, or particularly, in a range of about 10 to 200° C. The first solvent may be an organic solvent having a boiling temperature of 110° C. or greater. For example, the first solvent may be selected from the group consisting of anisole, toluene, xylene, methyl ethyl ketone, methyl iso-butyl ketone and ethylene glycol monomethyl ether, ethylene glycol monoethyl ether, ethylene glycol mono-butyl ether, acetic butyl, cyclohexanone, ethylene glycol monoethyl ether acetate (BCA), benzene, hexane, DMSO, N,N′-dimethylformamide, and a mixture of at least two thereof.

The second solvent may be an organic solvent having a boiling temperature of about 110° C. or less. For example, the low boiling point organic solvent may be selected from the group consisting of methyl alcohol, ethyl alcohol, propyl alcohol, n-butyl alcohol, iso-butyl alcohol, tert-butyl alcohol, acetone, methylenechloride, ethylene acetate, isopropyl alcohol, and a mixture of at least two thereof.

Further, the first solvent may be an aqueous solvent that may be selected from the group consisting of water, methanol, ethanol, ethyl acetate, and a mixture of at least two thereof.

According to an example of the present invention, the aqueous solvent may include a polyamideimide resin and an aerogel in the polyamideimide resin, for example, as being dispersed, and the thus prepared insulation coating layer may have a thermal conductivity of 0.60 W/m or less. Inventors of the present invention have manufactured an insulation coating layer to have improved mechanical properties and heat resistant property while having low thermal conductivity and low density using the exemplary insulation coating composition as described above. As consequence, the efficiency of the internal combustion engine and fuel consumption of the vehicle may be improved by reducing heat energy released to the outside as the insulation coating layer is applied to the internal combustion engine.

The aerogel may be uniformly dispersed in the insulation coating layer through the entire region of the polyamideimide resin. Accordingly, a material property, for example, low thermal conductivity and low density implemented from the aerogel may be easily ensured. Further, properties obtained from the polyamideimide resin, for example, high mechanical properties and a heat resistant property, may be implemented with an equivalent level when only the polyamideimide resin is used.

The insulation coating layer may provide low thermal conductivity and improved heat capacity. In detail, the insulation coating layer may have thermal conductivity of about 0.60 W/m or less, or 0.55 W/m or less, or may be in the range of about 0.60 W/m to 0.200 W/m. The insulation coating layer may have heat capacity of about 1250 KJ/m³ K or less, or particularly of about 1000 to 1250 KJ/m³ K.

As described above, since the example of the insulation coating composition includes the polyamideimide resin dispersed in the first solvent such as the high boiling point organic solvent or the aqueous solvent, and the aerogel dispersed in the second solvent such as the low boiling point organic solvent, and direct contact between the polyamideimide resin and the aerogel may be minimized before the coating composition is coated and dried, the polyamideimide resin may be prevented from penetrating or impregnating into the inside of pores of the aerogel included in the finally manufactured insulation coating layer. In detail, the polyamideimide resin may not be substantially included in the aerogel dispersed in the polyamideimide resin. For example, an amount of about 2 wt % or less, or particularly of about 1 wt % or less of the polyamideimide resin may be included in or penetrate the aerogel.

In addition, the aerogel may be included in the polyamideimide resin, for example, as being dispersed, in the insulation coating layer. In this case, the outside of the aerogel may make contact with or be coupled with the polyamideimide resin, but the polyamideimide resin may not be included inside the aerogel. In particular, the polyamideimide resin may not be included or penetrate at a depth of about 5% or greater of the longest diameter from a surface of the aerogel included in the insulation coating layer.

Since the polyamideimide resin is not penetrated or impregnated into the inside or pores of the aerogel, the aerogel may maintain a pore rate of an equivalent level before or after being dispersed in the polyamideimide resin. In particular, each aerogel included in the insulation coating layer may have a pore rate in the range of about 92% to 99% while being dispersed in the polyamideimide resin.

The insulation coating layer may provide an insulation material or an insulation structure which may be maintained for extended time inside the internal combustion engine to which the high temperature and high pressure condition is repeatedly applied. The exemplary insulation coating layer may be formed on an internal surface of the internal combustion engine or a component of the internal combustion engine. Furthermore, as described above, the exemplary insulation coating layer may be formed on the surface of the intake port of the cylinder head.

A thickness of the insulation coating layer may be determined according to an applied field or position or a required material property. For example, the thickness of the insulation coating layer may be in the range of about 50 μm to 500 μm. The example of the insulation coating layer may include the aerogel in an amount about 5 to 50 parts by weight, or 10 to 45 parts by weight, based on 100 parts by weight of the polyamideimide resin excluding the solvent content. If a content of the aerogel is less than the predetermined amount, for example, less than about 5 parts by weight, based on the polyamideimide resin, it may be difficult to reduce the thermal conductivity of the insulation coating layer and the density, to sufficiently ensure the heat resistant property, and to reduce the heat resistant property of the insulation coating layer.

Further, if the content of the aerogel is greater than the predetermined amount, for example, greater than about 50 parts by weight, based on the polyamideimide resin, it may be difficult to sufficiently obtain mechanical material properties of the insulation coating layer, and cracks may occur in the insulation coating layer or it may be difficult to firmly maintain a coating form of the insulation layer. The polyamideimide resin may have a weight average molecular weight in the range of about 3000 to 300,000 or particularly of about 4000 to 100,000. The aerogel may include at least one compound selected from the group consisting of a silicon oxide, carbon, a polyimide, and a metal carbide. The aerogel may have a specific surface area in the range of about 100 cm³/g to 1000 cm³/g. Detailed contents with respect to the polyamideimide resin and the aerogel include the above contents with respect to the example of the insulation coating composition.

The insulation coating layer may be obtained by drying the insulation coating composition. A device or a method used to dry the example of the insulation coating composition may not be particularly limited. For example, a natural drying method at room temperature or greater or a method of drying the insulation coating composition at a temperature of 50° C. or higher may be used, without limitation. The insulation coating composition may be coated on a coating target, for example, an internal surface of the internal combustion engine or an external surface of a component of the internal combustion engine, the insulation coating composition may be semi-dried at a temperature of about 50° C. to 200° C. at least once, and the semi-dried coating composition may be completely dried at a temperature of about 200° C. or greater such that the insulation coating layer may be formed. However, a detailed method of manufacturing the example of the insulation coating layer may not be limited thereto.

### EXAMPLE

Exemplary embodiments according to the present invention will be described in detail below. However, a following exemplary embodiments only illustrative the present invention, and contents of the present invention are not limited to the following exemplary embodiments.

### Exemplary Embodiments 1 to 3

### 1 Manufacture of Insulation Coating Composition

A porous silica aerogel (having a specific surface area of about 500 cm³/g) dispersed in ethyl alcohol and a polyamideimide resin (product of Solvay Corporation, having a weight average molecular weight of about 11,000) dispersed in xylene are injected into a 20 g reaction device, zirconia beads of about 440 g are added, and ball milling is performed at a room temperature and normal pressure condition at a speed of about 150 to 300 rpm such that an insulation coating composition (coating solution) is manufactured.

In this case, a weight ratio of the porous silica aerogel to the polyamideimide resin is listed in the following Table 1.

### (2) Formation of Insulation Coating Layer

The obtained insulation coating composition is coated on a component for a vehicle engine in a spray coating scheme. After the insulation coating composition is coated on the component and is primarily semi-dried at a temperature of about 150° C. for about 10 minutes, the insulation coating composition is recoated and is secondarily semi-dried at about 150° C. for about 10 minutes. After the secondary semi-drying, the insulation coating composition is recoated and is completely dried at a temperature of about 150° C. for about 60 minutes such that the insulation coating layer is formed on the component. In this case, a thickness of the formed coating layer is as listed in the following Table 1.

### Comparative Example 1

A polyamideimide resin (product of Solvay Corporation, having a weight average molecular weight of about 11,000) dispersed in xylene is coated on the component for the vehicle engine in a solution (PAI solution) spray coating scheme.

After the PAI solution is coated on the component and is primarily semi-dried at about 150° C. for about 10 minutes, the PAI solution is recoated and is secondarily semi-dried at about 150° C. for about 10 minutes. After the secondary semi-drying, the PAI solution is recoated and is completely dried at a temperature of about 250° C. for about 60 minutes so that the insulation coating layer is formed on the component. In this case, the thickness of the formed coating layer is as listed in the following Table 1.

### Comparative Example 2

### (1) Manufacture of Coating Composition

A porous silica aerogel (having a specific surface area of about 500 cm³/g) and a polyamideimide resin (product of Solvay corporation, having a weight average molecular weight of about 11,000) are injected into a 20 g reaction device, zirconia beads at about 440 g are added, and ball milling is performed at a room temperature and normal pressure condition at speed of 150 to 300 rpm so that an insulation coating composition (coating solution) is manufactured.

In this case, a weight ratio of the porous silica aerogel to the polyamideimide resin is as listed in the following Table 1.

### (2) Formation of Insulation Coating Layer

A coating layer having a thickness of about 200 μm is formed in the same manner as in Exemplary Embodiment 1.

### Experimental Examples

### 1. Experiment Example 1

### Measurement of Thermal Conductivity

Thermal conductivity of the coating layer of the component obtained from the exemplary embodiment and the comparative example is measured by a thermal diffusion method using a laser flash method in a room temperature and normal pressure condition according to standard ASTM E1461.

### 2. Experimental Example 2

### Measurement of Heat Capacity

Specific heat of a coating layer on the component obtained from the exemplary embodiment and the comparative example is measured by using sapphire as a reference using a DSC device at a room temperature condition according to standard ASTM E1269, and heat capacity is confirmed.

TABLE 1

| | Aerogel content | Coating | Thermal | Heat |
|---|---|---|---|---|
| | (weight parts) | layer | conduc- | capac- |
| | based on PAI | thick- | tivity of | ity of |
| | resin 100 | ness | coating layer | coating layer |
| | weight parts | (μm) | [W/m] | [KJ/m³ K] |
| Exemplary | 15 | 120 | 0.54 | 1216 |
| Embodiment 1 | | | | |
| Exemplary | 20 | 200 | 0.331 | 1240 |
| Embodiment 2 | | | | |
| Exemplary | 40 | 200 | 0.294 | 1124 |
| Embodiment 3 | | | | |
| Comparative | — | 200 | 0.56 | 1221 |
| Example 1 | | | | |

As listed in the Table 1, it is confirmed that the insulation coating layer obtained from the exemplary embodiment 1 to 3 has heat capacity of about 1240 KJ/m³ K or less and a thermal conductivity of about 0.54 W/m or less in a thickness of the range of about 120 to 200 nm. Accordingly, the insulation coating layer obtained from Exemplary Embodiments 1 to 3 is applied to coat a component of the internal combustion engine such that externally released heat energy may be reduced to improve the efficiency of the internal combustion engine and fuel consumption of the vehicle.

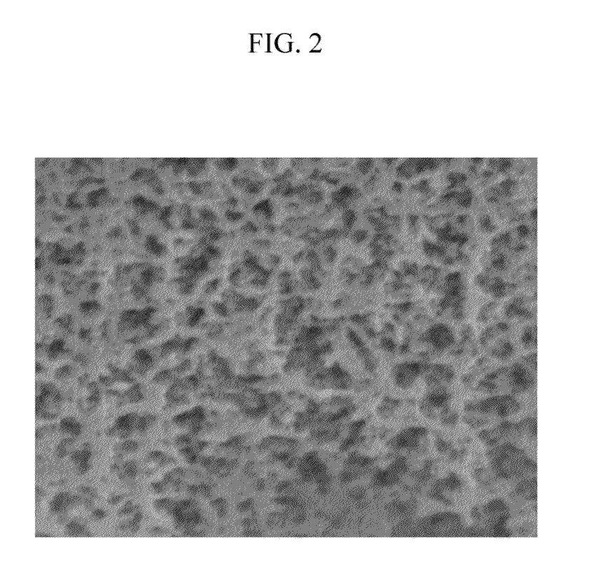

Further, as illustrated in FIG. 2, in the insulation coating layer manufactured from Exemplary Embodiment 1, a polyamideimide resin does not penetrate into the aerogel and the aerogel may maintain internal pores at about 92%.

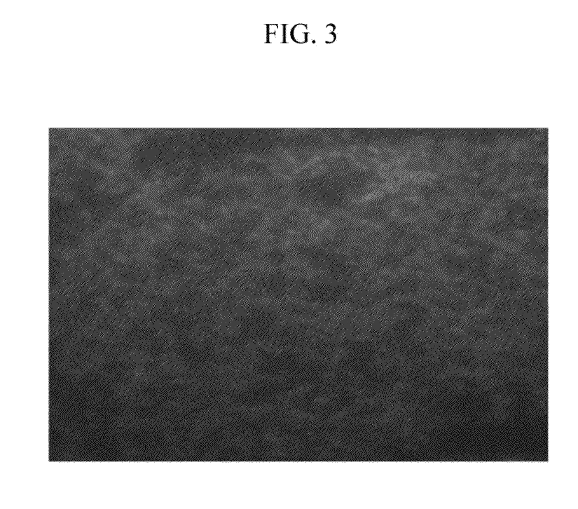

In contrast, in the coating layer manufactured from Comparative Example 2, as illustrated in FIG. 3, the polyamideimide resin does not penetrate into the aerogel such that pores are scarcely observed.

According to a cylinder head 100 for an engine according to an exemplary embodiment of the present invention, an increase in temperature of intake air is suppressed to reduce knocking of the engine by applying an insulation coating layer capable of ensuring mechanical material properties and a heat resistant property while representing low thermal conductivity and low volume heat capacity. Accordingly, an exemplary embodiment of the present invention may improve fuel consumption by ignition timing advance due to knocking reduction and improve engine output due to an increase in intake charging efficiency.

Exemplary embodiments of the present invention are disclosed herein, but the present invention is not limited to the disclosed embodiments, and on the contrary, is intended to cover various modifications and equivalent arrangements included within the appended claims and the detailed description and the accompanying drawings of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A cylinder head for an engine, comprising an insulation layer formed on a surface of an intake port surface,
wherein the insulating layer comprises a polyamideimide resin and an aerogel in the polyamideimide resin, and the insulation coating layer has a thermal conductivity of about 0.60 W/m or less.

2. The cylinder head for an engine of claim 1, wherein the aerogel is dispersed in the polyamideimide resin.

3. The cylinder head for an engine of claim 1, wherein the insulation coating layer has heat capacity of about 1250 KJ/m³ K or less.

4. The cylinder head for an engine of claim 1, wherein an amount of about 2 wt % or less of the polyamideimide based on the total weight of the polyamideimide resin is included in the aerogel.

5. The cylinder head for an engine of claim 1, wherein the polyamideimide resin is not included at a depth of about 5% or greater of a longest diameter from a surface of the aerogel.

6. The cylinder head for an engine of claim 1, wherein the aerogel has a pore rate in a range of about 92% to 99% as being dispersed in the polyamideimide resin.

7. The cylinder head for an engine of claim 1, wherein the insulation coating layer has a thickness in a range of about 50 μm to 500 μm.

8. The cylinder head for an engine of claim 1, wherein the insulation coating layer comprises the aerogel in an amount of about 5 to 50 parts by weight based on the polyamideimide resin at 100 parts by weight.

9. A vehicle that comprises a cylinder head of claim 1.

10. A method for preparing an insulation coating layer of a cylinder head for an engine, comprising:
preparing an insulation coating composition;
applying the insulation coating composition on a surface of a subject; and
drying the insulation coating composition,
wherein the insulation coating layer comprises a polyamideimide resin and an aerogel in the polyamideimide resin, and the insulation coating layer having thermal conductivity of about 0.60 W/m or less is formed.

11. The method of claim 10, wherein the aerogel is dispersed in the polyamideimide resin.

12. The method of claim 11, wherein the insulation coating composition comprises the polyamideimide resin dispersed in a first solvent and the aerogel dispersed in a second solvent.

13. The method of claim 12, wherein the first solvent has a boiling point of about 110° C. or greater and the second solvent has a boiling point of about 110° C. or less.

14. The method of claim 11, wherein the polyamideimide resin has a weight average molecular weight of about 3000 to 300,000.

15. The method of claim 11, wherein the aerogel is made of at least one compound selected from the group consisting of a silicon oxide, carbon, a polyimide, and a metal carbide.

16. The method of claim 11, wherein a solid content of the polyamideimide resin is in a range of about 5 wt % to 75 wt % based on the total weight of the first solvent.

17. The method of claim 11, wherein a solid content of the aerogel is in a range of about 5 wt % to 75 wt % based on the total weight of the second solvent.

18. The method of claim 11, wherein the insulation coating layer comprises the aerogel in an amount of about 5 to 50 parts by weight based on the polyamideimide resin at 100 parts by weight.

19. The method of claim 11, wherein the insulation coating composition is semi-dried at a temperature of about 50° C. to 200° C. at least once, and the semi-dried insulation coating composition is completely dried at a temperature of about 200° C. or greater.

20. The method of claim 10, wherein the subject is an intake port.
